(19) United States
(12) Patent Application Publication
(10) Pub. No.: US 2021/0191683 A1
(43) Pub. Date: Jun. 24, 2021

(54) METHOD AND SYSTEM FOR SIMULTANEOUSLY DRIVING DUAL DISPLAYS WITH SAME CAMERA VIDEO DATA AND DIFFERENT GRAPHICS

(71) Applicant: GoPro, Inc., San Mateo, CA (US)

(72) Inventors: Naveen Chinya Krishnamurthy, Fremont, CA (US); Michael A. Ramirez, Mountain View, CA (US)

(21) Appl. No.: 17/121,439

(22) Filed: Dec. 14, 2020

Related U.S. Application Data
(60) Provisional application No. 62/949,547, filed on Dec. 18, 2019.

(51) Int. Cl. G06F 3/14; H04N 5/232; G09G 3/20; G06T 3/40; G06T 11/00; G06T 11/60; H04N 5/76

(52) U.S. Cl. CPC G06F 3/1438; H04N 5/232933; H04N 5/23229; G09G 3/20; G09G 2354/00; G06T 11/001; G06T 11/60; H04N 5/76; G09G 2360/04; G06T 3/40

(57) ABSTRACT

An image capture system includes an image sensor configured to capture image information, a display module configured to blend image information with first user interface graphics and text to generate first image information for a first display, a processor configured to process the image information for use for a second display, blend the processed image information with second user interface graphics and text to generate second image information for a second display, and store the second image information in a buffer of a triple buffer structure, a first display driver for generating signals from the first image information to drive the first display, and a second display driver for generating signals from the second image information to drive the second display, where the first display driver and the second display driver are different display driver types.

### CROSS REFERENCE TO RELATED APPLICATION

This application claims priority to and the benefit of U.S. Provisional Patent Application No. 62/949,547, filed on Dec. 18, 2019, the entire content of which is incorporated by reference.

### TECHNICAL FIELD

This disclosure relates to systems and techniques for driving camera displays.

### BACKGROUND

Image capture devices, such as cameras, may capture content as images or video. Light may be received and focused via a lens and may be converted to an electronic image signal by an image sensor. The image signal may be processed by an image signal processor (ISP) to form an image, which may then be stored or output for display on a camera display. In some cases, an image capture device may include a front display and a rear display. However, the image capture device may only include drive circuitry to display video on either the front display or the rear display.

### SUMMARY

Disclosed herein are implementations of systems and techniques for simultaneously driving dual displays with same camera video and different graphics.

In some implementations, an image capture system includes an image sensor configured to capture image information, a display module configured to blend image information with first user interface graphics and text to generate first image information for a first display, a processor configured to process the image information for use for a second display, blend the processed image information with second user interface graphics and text to generate second image information for a second display, and store the second image information in a buffer of a triple buffer structure, a first display driver for generating signals from the first image information to drive the first display, and a second display driver for generating signals from the second image information to drive the second display, where the first display driver and the second display driver are different display driver types.

In some implementations, the first display is a rear display and the second display front display. In some implementations, the storing includes storing a frame of the second image information in one of a pair of buffers of the triple buffer structure. In some implementations, the storing includes reading a different frame of the second image information from another buffer of the triple buffer structure. In some implementations, the processing includes color converting the image information for use for the second display. In some implementations, the processing includes scaling the color converted image information for use for the second display. In some implementations, the processing includes color converting the second user interface graphics and text for use for the second display. In some implementations, the processing includes scaling the color converted second user interface graphics and text for user for the second display.

In some implementations, a method for simultaneously driving dual displays with video data includes overlaying, by a display module, the video data with rear user interface graphics and text to generate rear video data for a rear display, processing, by a processor, the video data for a front display, overlaying the processed video data with front user interface graphics and text to generate front video data for the front display, storing the front video data in a buffer of a triple buffer structure, generating a first type of driving signals from the rear video data to drive the rear display, and generating a second type of driving signals from the front video data to drive the front display, where the first type of driving signals and the second type of driving signals are different driving signals.

In some implementations, the method further includes storing a frame of the front video data in one of a pair of buffers of the triple buffer structure. In some implementations, the method further includes reading a different frame of the front video data from another buffer of the triple buffer structure. In some implementations, the processing includes color converting the video data for use for the front display. In some implementations, the processing includes scaling the color converted video data for use for the front display. In some implementations, the processing includes color converting the front user interface graphics and text for use for the front display. In some implementations, the processing includes scaling the color converted front user interface graphics and text for use for the front display.

In some implementations, a system for simultaneously driving dual displays with video data includes an image sensor configured to capture the video data, a display module configured to overlay the video data with rear user interface graphics and text to generate rear video data for a rear display, and a processor, in cooperation the display module, configured to process the video data for a front display, overlay the processed video data with front user interface graphics and text to generate front video data for the front display, store the front video data in a buffer of a triple buffer structure, generate a first type of driving signals from the rear video data to drive the rear display, and generate a second type of driving signals from the front video data to drive the front display, wherein the first type of driving signals and the second type of driving signals are different driving signals.

In some implementations, the processor configured to store a frame of the front video data in one of a pair of buffers of the triple buffer structure. In some implementations, the processor configured to read a different frame of the front video data from another buffer of the triple buffer structure. In some implementations, the processor configured to color convert the video data for use for the front display and scale the color converted video data for use for the front display. In some implementations, the processor configured to color convert the front user interface graphics and text for use for the front display and scale the color converted front user interface graphics and text for use for the front display.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-D are isometric views of an example of an image capture device.

FIGS. 2A-B are isometric views of another example of an image capture device.

FIG. 2C is a cross-sectional view of the image capture device of FIGS. 2A-B.

FIGS. 3A-B are block diagrams of examples of image capture systems.

FIGS. 4A-B are a perspective view and a schematic representation of an image capture device.

FIG. 5 is a block diagram of an example of an image capture and processing pipeline for simultaneously driving dual displays with same camera video and different graphics.

FIG. 6 is a flow diagram of an example of triple buffering for simultaneously driving dual displays with same camera video and different graphics.

FIG. 7 is a flowchart of an example of a process for simultaneously driving dual displays with same camera video and different graphics.

FIG. 8 is a flowchart of an example of a process for triple buffering for simultaneously driving dual displays with same camera video and different graphics.

### DETAILED DESCRIPTION

Image capture devices have dual displays which include a front display and a rear display. Each display includes display driving circuitry or a display driver which interfaces between a processor and the display by accepting commands and data and generating signals to make the display show desired text, graphics, image, video, or combinations thereof. In some instances, the image capture device may include a Mobile Industry Processor Interface (MIPI) Display Serial Interface (DSI) compatible display driver to drive one of the dual displays. A display module in the image capture device processes video data and user interface graphics and text (collectively first display data) and the MIPI DSI driver drives a first display to show the first display data at a defined frame rate. The second display may be limited to showing only user interface graphics and text as the image capture device may not have a second MIPI DSI driver due to resource expenses.

Implementations of this disclosure address problems such as these by using a serial peripheral interface (SPI) in combination with a triple buffer architecture to drive the second display with the same video data and different user interface graphics and text. A processor in the image capture device processes the same video data and different user interface graphics and text (collectively second display data) and the SPI driver drives the second display to show the second display data such that the defined frame rate of the first display is unaffected. The triple buffer architecture permits writing of the second display data between alternate buffers while contents of a third buffer are shown on the second display.

The implementations of this disclosure are described in detail with reference to the drawings, which are provided as examples so as to enable those skilled in the art to practice the technology. The figures and examples are not meant to limit the scope of the present disclosure to a single implementation, and other implementations are possible by way of interchange of, or combination with, some or all of the described or illustrated elements. Wherever convenient, the same reference numbers will be used throughout the drawings to refer to same or like parts.

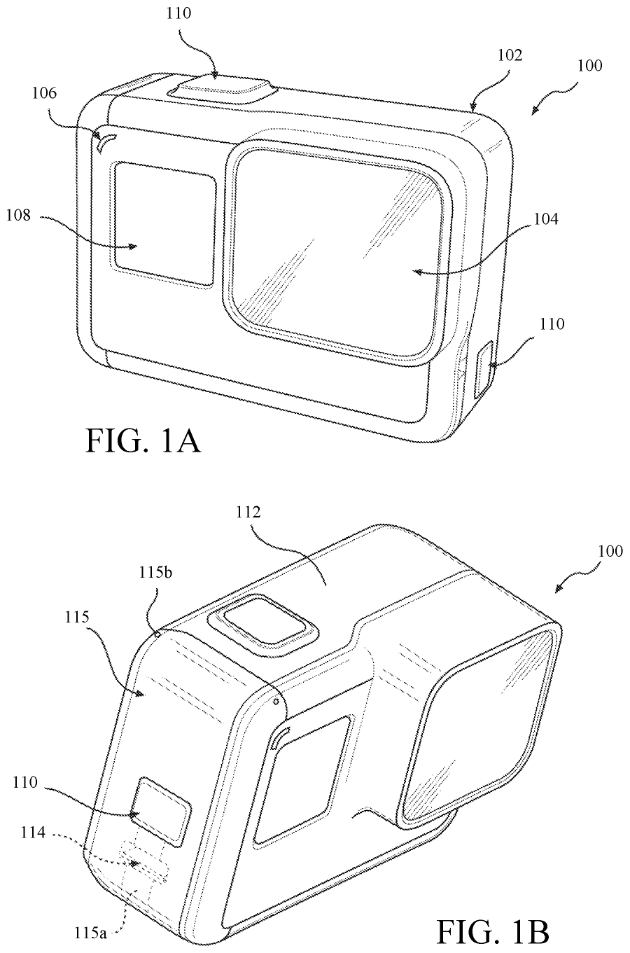

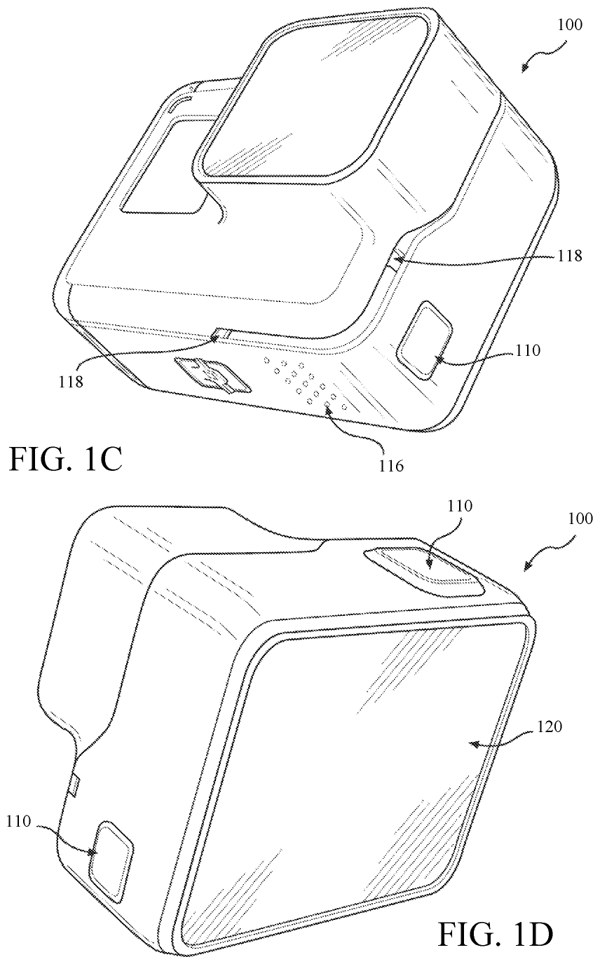

FIGS. 1A-D are isometric views of an example of an image capture device 100. The image capture device 100 may include a body 102 having a lens 104 structured on a front surface of the body 102, various indicators on the front of the surface of the body 102 (such as LEDs, displays, and the like), various input mechanisms (such as buttons, switches, and touch-screen mechanisms), and electronics (e.g., imaging electronics, power electronics, etc.) internal to the body 102 for capturing images via the lens 104 and/or performing other functions. The image capture device 100 may be configured to capture images and video and to store captured images and video for subsequent display or playback.

The image capture device 100 may include various indicators, including LED lights 106 and LCD display 108. The image capture device 100 may also include buttons 110 configured to allow a user of the image capture device 100 to interact with the image capture device 100, to turn the image capture device 100 on, to operate latches or hinges associated with doors of the image capture device 100, and/or to otherwise configure the operating mode of the image capture device 100. The image capture device 100 may also include a microphone 112 configured to receive and record audio signals in conjunction with recording video.

The image capture device 100 may include an I/O interface 114 (e.g., hidden as indicated using dotted lines). As best shown in FIG. 1B, the I/O interface 114 can be covered and sealed by a removable door 115 of the image capture device 100. The removable door 115 can be secured, for example, using a latch mechanism 115a (e.g., hidden as indicated using dotted lines) that is opened by engaging the associated button 110 as shown.

The removable door 115 can also be secured to the image capture device 100 using a hinge mechanism 115b, allowing the removable door 115 to pivot between an open position allowing access to the I/O interface 114 and a closed position blocking access to the I/O interface 114. The removable door 115 can also have a removed position (not shown) where the entire removable door 115 is separated from the image capture device 100, that is, where both the latch mechanism 115a and the hinge mechanism 115b allow the removable door 115 to be removed from the image capture device 100.

The image capture device 100 may also include another microphone 116 integrated into the body 102 or housing. The front surface of the image capture device 100 may include two drainage ports as part of a drainage channel 118. The image capture device 100 may include an interactive display 120 that allows for interaction with the image capture device 100 while simultaneously displaying information on a surface of the image capture device 100. As illustrated, the image capture device 100 may include the lens 104 that is configured to receive light incident upon the lens 104 and to direct received light onto an image sensor internal to the lens 104.

The image capture device 100 of FIGS. 1A-D includes an exterior that encompasses and protects internal electronics. In the present example, the exterior includes six surfaces (i.e. a front face, a left face, a right face, a back face, a top face, and a bottom face) that form a rectangular cuboid. Furthermore, both the front and rear surfaces of the image capture device 100 are rectangular. In other embodiments, the exterior may have a different shape. The image capture device 100 may be made of a rigid material such as plastic, aluminum, steel, or fiberglass. The image capture device 100 may include features other than those described here. For example, the image capture device 100 may include additional buttons or different interface features, such as interchangeable lenses, cold shoes and hot shoes that can add functional features to the image capture device 100, etc.

The image capture device 100 may include various types of image sensors, such as a charge-coupled device (CCD) sensors, active pixel sensors (APS), complementary metal-oxide-semiconductor (CMOS) sensors, N-type metal-oxide-semiconductor (NMOS) sensors, and/or any other image sensor or combination of image sensors.

Although not illustrated, in various embodiments, the image capture device 100 may include other additional electrical components (e.g., an image processor, camera SoC (system-on-chip), etc.), which may be included on one or more circuit boards within the body 102 of the image capture device 100.

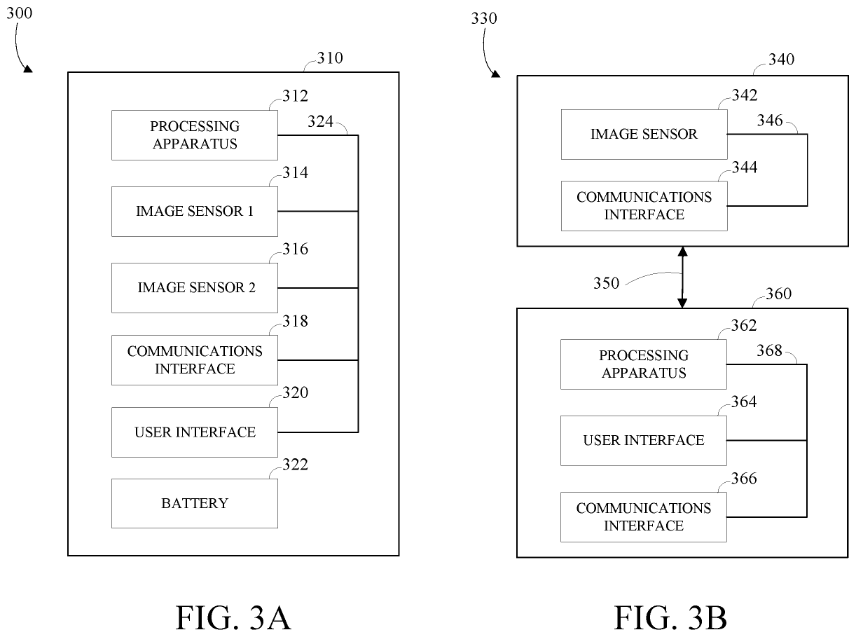

The image capture device 100 may interface with or communicate with an external device, such as an external user interface device, via a wired or wireless computing communication link (e.g., the I/O interface 114). The user interface device may, for example, be the personal computing device 360 described below with respect to FIG. 3B. Any number of computing communication links may be used. The computing communication link may be a direct computing communication link or an indirect computing communication link, such as a link including another device or a network, such as the internet, may be used.

In some implementations, the computing communication link may be a Wi-Fi link, an infrared link, a Bluetooth (BT) link, a cellular link, a ZigBee link, a near field communications (NFC) link, such as an ISO/IEC 20643 protocol link, an Advanced Network Technology interoperability (ANT+) link, and/or any other wireless communications link or combination of links.

In some implementations, the computing communication link may be an HDMI link, a USB link, a digital video interface link, a display port interface link, such as a Video Electronics Standards Association (VESA) digital display interface link, an Ethernet link, a Thunderbolt link, and/or other wired computing communication link.

The image capture device 100 may transmit images, such as panoramic images, or portions thereof, to the user interface device (not shown) via the computing communication link, and the user interface device may store, process, display, or a combination thereof the panoramic images.

The user interface device may be a computing device, such as a smartphone, a tablet computer, a phablet, a smart watch, a portable computer, and/or another device or combination of devices configured to receive user input, communicate information with the image capture device 100 via the computing communication link, or receive user input and communicate information with the image capture device 100 via the computing communication link.

The user interface device may display, or otherwise present, content, such as images or video, acquired by the image capture device 100. For example, a display of the user interface device may be a viewport into the three-dimensional space represented by the panoramic images or video captured or created by the image capture device 100.

The user interface device may communicate information, such as metadata, to the image capture device 100. For example, the user interface device may send orientation information of the user interface device with respect to a defined coordinate system to the image capture device 100, such that the image capture device 100 may determine an orientation of the user interface device relative to the image capture device 100.

Based on the determined orientation, the image capture device 100 may identify a portion of the panoramic images or video captured by the image capture device 100 for the image capture device 100 to send to the user interface device for presentation as the viewport. In some implementations, based on the determined orientation, the image capture device 100 may determine the location of the user interface device and/or the dimensions for viewing of a portion of the panoramic images or video.

The user interface device may implement or execute one or more applications to manage or control the image capture device 100. For example, the user interface device may include an application for controlling camera configuration, video acquisition, video display, or any other configurable or controllable aspect of the image capture device 100.

The user interface device, such as via an application, may generate and share, such as via a cloud-based or social media service, one or more images, or short video clips, such as in response to user input. In some implementations, the user interface device, such as via an application, may remotely control the image capture device 100 such as in response to user input.

The user interface device, such as via an application, may display unprocessed or minimally processed images or video captured by the image capture device 100 contemporaneously with capturing the images or video by the image capture device 100, such as for shot framing, which may be referred to herein as a live preview, and which may be performed in response to user input. In some implementations, the user interface device, such as via an application, may mark one or more key moments contemporaneously with capturing the images or video by the image capture device 100, such as with a tag, such as in response to user input.

The user interface device, such as via an application, may display, or otherwise present, marks or tags associated with images or video, such as in response to user input. For example, marks may be presented in a camera roll application for location review and/or playback of video highlights.

The user interface device, such as via an application, may wirelessly control camera software, hardware, or both. For example, the user interface device may include a web-based graphical interface accessible by a user for selecting a live or previously recorded video stream from the image capture device 100 for display on the user interface device.

The user interface device may receive information indicating a user setting, such as an image resolution setting (e.g., 3840 pixels by 2160 pixels), a frame rate setting (e.g., 60 frames per second (fps)), a location setting, and/or a context setting, which may indicate an activity, such as mountain biking, in response to user input, and may communicate the settings, or related information, to the image capture device 100.

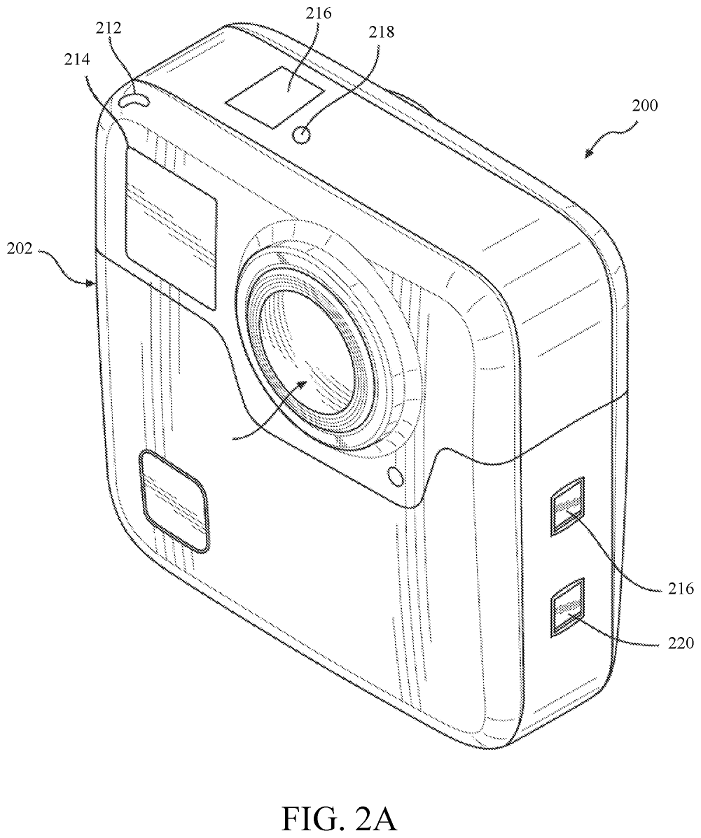

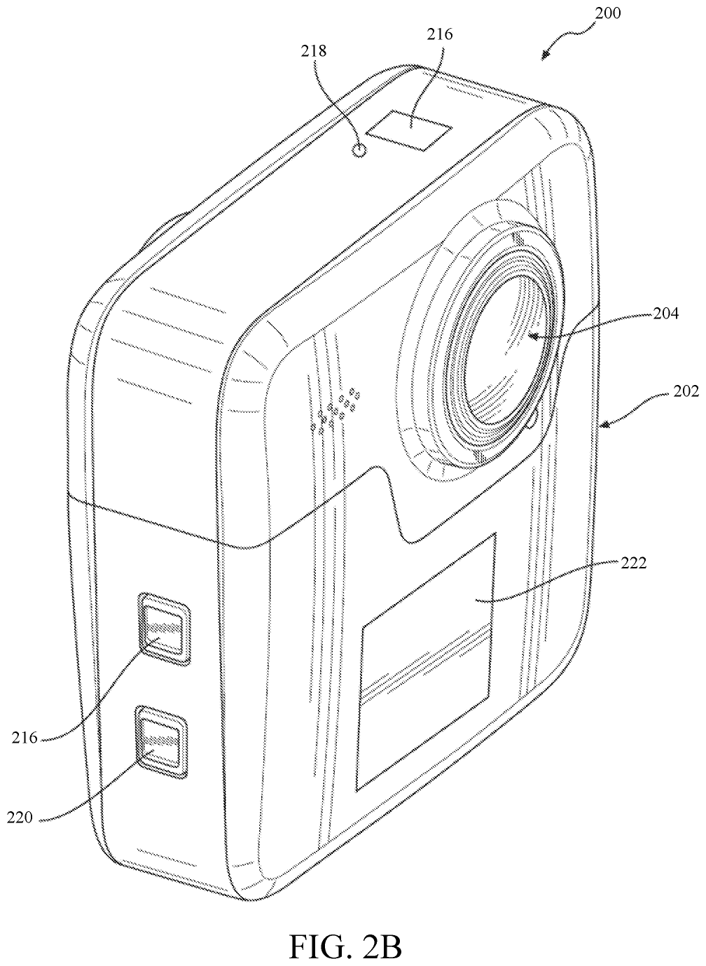

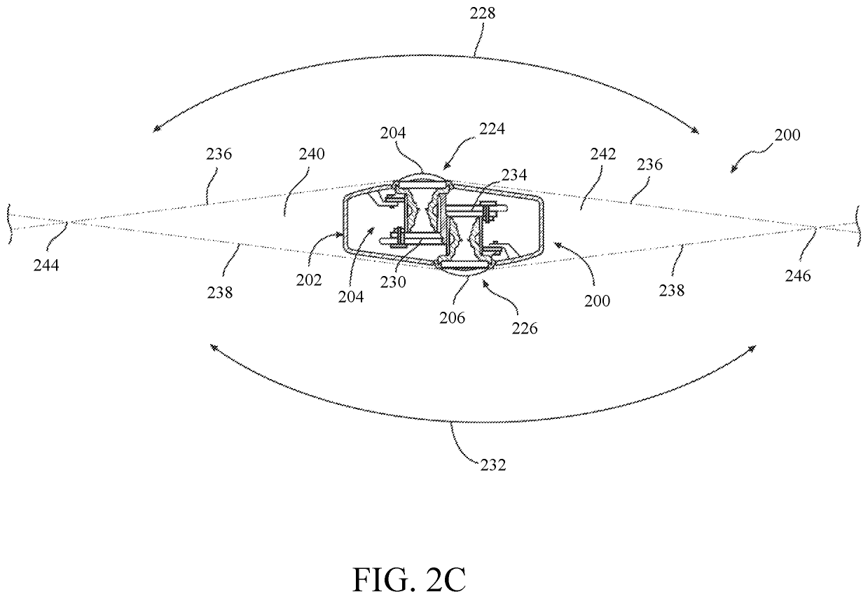

FIGS. 2A-B illustrate another example of an image capture device 200. The image capture device 200 includes a body 202 and two camera lenses 204, 206 disposed on opposing surfaces of the body 202, for example, in a back-to-back or Janus configuration.

The image capture device may include electronics (e.g., imaging electronics, power electronics, etc.) internal to the body 202 for capturing images via the lenses 204, 206 and/or performing other functions. The image capture device may include various indicators such as an LED light 212 and an LCD display 214.

The image capture device 200 may include various input mechanisms such as buttons, switches, and touchscreen mechanisms. For example, the image capture device 200 may include buttons 216 configured to allow a user of the image capture device 200 to interact with the image capture device 200, to turn the image capture device 200 on, and to otherwise configure the operating mode of the image capture device 200. In an implementation, the image capture device 200 includes a shutter button and a mode button. It should be appreciated, however, that, in alternate embodiments, the image capture device 200 may include additional buttons to support and/or control additional functionality.

The image capture device 200 may also include one or more microphones 218 configured to receive and record audio signals (e.g., voice or other audio commands) in conjunction with recording video.

The image capture device 200 may include an I/O interface 220 and an interactive display 222 that allows for interaction with the image capture device 200 while simultaneously displaying information on a surface of the image capture device 200.

The image capture device 200 may be made of a rigid material such as plastic, aluminum, steel, or fiberglass. In some embodiments, the image capture device 200 described herein includes features other than those described. For example, instead of the I/O interface 220 and the interactive display 222, the image capture device 200 may include additional interfaces or different interface features. For example, the image capture device 200 may include additional buttons or different interface features, such as interchangeable lenses, cold shoes and hot shoes that can add functional features to the image capture device 200, etc.

FIG. 2C is a cross-sectional view of the image capture device 200 of FIGS. 2A-B. The image capture device 200 is configured to capture spherical images, and accordingly, includes a first image capture device 224 and a second image capture device 226. The first image capture device 224 defines a first field-of-view 228 as shown in FIG. 2C and includes the lens 204 that receives and directs light onto a first image sensor 230.

Similarly, the second image capture device 226 defines a second field-of-view 232 as shown in FIG. 2C and includes the lens 206 that receives and directs light onto a second image sensor 234. To facilitate the capture of spherical images, the image capture devices 224, 226 (and related components) may be arranged in a back-to-back (Janus) configuration such that the lenses 204, 206 face in generally opposite directions.

The fields-of-view 228, 232 of the lenses 204, 206 are shown above and below boundaries 236, 238, respectively. Behind the first lens 204, the first image sensor 230 may capture a first hyper-hemispherical image plane from light entering the first lens 204, and behind the second lens 206, the second image sensor 234 may capture a second hyper-hemispherical image plane from light entering the second lens 206.

One or more areas, such as blind spots 240, 242 may be outside of the fields-of-view 228, 232 of the lenses 204, 206 so as to define a “dead zone.” In the dead zone, light may be obscured from the lenses 204, 206 and the corresponding image sensors 230, 234, and content in the blind spots 240, 242 may be omitted from capture. In some implementations, the image capture devices 224, 226 may be configured to minimize the blind spots 240, 242.

The fields-of-view 228, 232 may overlap. Stitch points 244, 246, proximal to the image capture device 200, at which the fields-of-view 228, 232 overlap may be referred to herein as overlap points or stitch points. Content captured by the respective lenses 204, 206, distal to the stitch points 244, 246, may overlap.

Images contemporaneously captured by the respective image sensors 230, 234 may be combined to form a combined image. Combining the respective images may include correlating the overlapping regions captured by the respective image sensors 230, 234, aligning the captured fields-of-view 228, 232, and stitching the images together to form a cohesive combined image.

A slight change in the alignment, such as position and/or tilt, of the lenses 204, 206, the image sensors 230, 234, or both, may change the relative positions of their respective fields-of-view 228, 232 and the locations of the stitch points 244, 246. A change in alignment may affect the size of the blind spots 240, 242, which may include changing the size of the blind spots 240, 242 unequally.

Incomplete or inaccurate information indicating the alignment of the image capture devices 224, 226, such as the locations of the stitch points 244, 246, may decrease the accuracy, efficiency, or both of generating a combined image. In some implementations, the image capture device 200 may maintain information indicating the location and orientation of the lenses 204, 206 and the image sensors 230, 234 such that the fields-of-view 228, 232, stitch points 244, 246, or both may be accurately determined, which may improve the accuracy, efficiency, or both of generating a combined image.

The lenses 204, 206 may be laterally offset from each other, may be off-center from a central axis of the image capture device 200, or may be laterally offset and off-center from the central axis. As compared to image capture devices with back-to-back lenses, such as lenses aligned along the same axis, image capture devices including laterally offset lenses may include substantially reduced thickness relative to the lengths of the lens barrels securing the lenses. For example, the overall thickness of the image capture device 200 may be close to the length of a single lens barrel as opposed to twice the length of a single lens barrel as in a back-to-back configuration. Reducing the lateral distance between the lenses 204, 206 may improve the overlap in the fields-of-view 228, 232.

Images or frames captured by the image capture devices 224, 226 may be combined, merged, or stitched together to produce a combined image, such as a spherical or panoramic image, which may be an equirectangular planar image. In some implementations, generating a combined image may include three-dimensional, or spatiotemporal, noise reduction (3DNR). In some implementations, pixels along the stitch boundary may be matched accurately to minimize boundary discontinuities.

FIGS. 3A-B are block diagrams of examples of image capture systems. Referring first to FIG. 3A, an image capture system 300 is shown. The image capture system 300 includes an image capture device 310 (e.g., a camera or a drone), which may, for example, be the image capture device 200 shown in FIGS. 2A-C.

The image capture device 310 includes a processing apparatus 312 that is configured to receive a first image from a first image sensor 314 and receive a second image from a second image sensor 316. The image capture device 310 includes a communications interface 318 for transferring images to other devices. The image capture device 310 includes a user interface 320 to allow a user to control image capture functions and/or view images. The image capture device 310 includes a battery 322 for powering the image capture device 310. The components of the image capture device 310 may communicate with each other via the bus 324.

The processing apparatus 312 may be configured to perform image signal processing (e.g., filtering, tone mapping, stitching, and/or encoding) to generate output images based on image data from the image sensors 314 and 316. The processing apparatus 312 may include one or more processors having single or multiple processing cores. The processing apparatus 312 may include memory, such as a random-access memory device (RAM), flash memory, or another suitable type of storage device such as a non-transitory computer-readable memory. The memory of the processing apparatus 312 may include executable instructions and data that can be accessed by one or more processors of the processing apparatus 312.

For example, the processing apparatus 312 may include one or more dynamic random access memory (DRAM) modules, such as double data rate synchronous dynamic random-access memory (DDR SDRAM). In some implementations, the processing apparatus 312 may include a digital signal processor (DSP). In some implementations, the processing apparatus 312 may include an application specific integrated circuit (ASIC). For example, the processing apparatus 312 may include a custom image signal processor.

The first image sensor 314 and the second image sensor 316 may be configured to detect light of a certain spectrum (e.g., the visible spectrum or the infrared spectrum) and convey information constituting an image as electrical signals (e.g., analog or digital signals). For example, the image sensors 314 and 316 may include CCDs or active pixel sensors in a CMOS. The image sensors 314 and 316 may detect light incident through a respective lens (e.g., a fisheye lens). In some implementations, the image sensors 314 and 316 include digital-to-analog converters. In some implementations, the image sensors 314 and 316 are held in a fixed orientation with respective fields of view that overlap.

The communications interface 318 may enable communications with a personal computing device (e.g., a smartphone, a tablet, a laptop computer, or a desktop computer). For example, the communications interface 318 may be used to receive commands controlling image capture and processing in the image capture device 310. For example, the communications interface 318 may be used to transfer image data to a personal computing device. For example, the communications interface 318 may include a wired interface, such as a high-definition multimedia interface (HDMI), a universal serial bus (USB) interface, or a FireWire interface. For example, the communications interface 318 may include a wireless interface, such as a Bluetooth interface, a ZigBee interface, and/or a Wi-Fi interface.

The user interface 320 may include an LCD display for presenting images and/or messages to a user. For example, the user interface 320 may include a button or switch enabling a person to manually turn the image capture device 310 on and off. For example, the user interface 320 may include a shutter button for snapping pictures.

The battery 322 may power the image capture device 310 and/or its peripherals. For example, the battery 322 may be charged wirelessly or through a micro-USB interface.

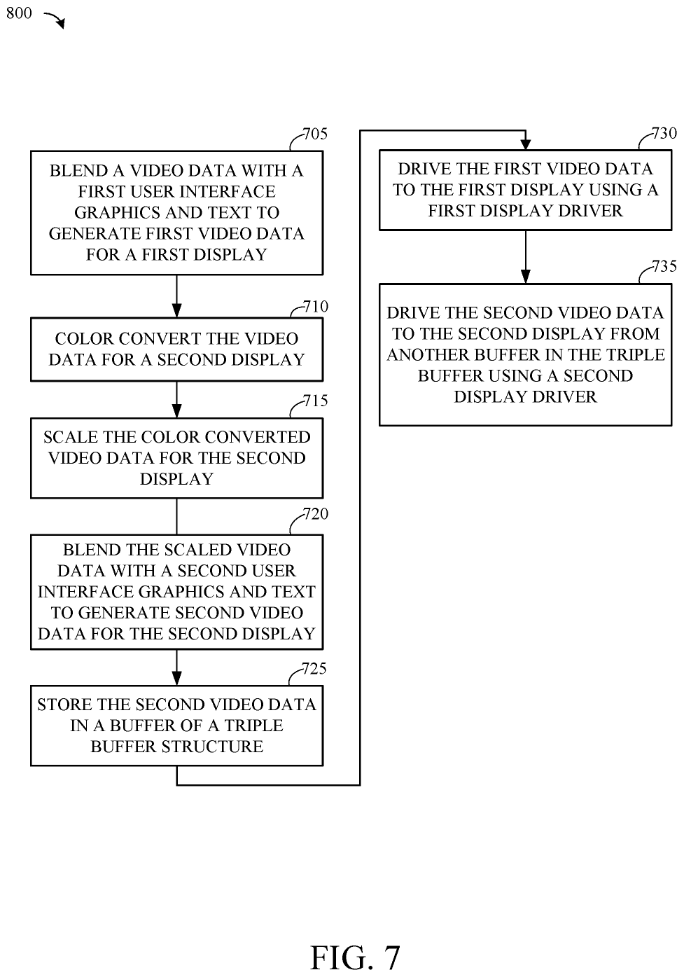

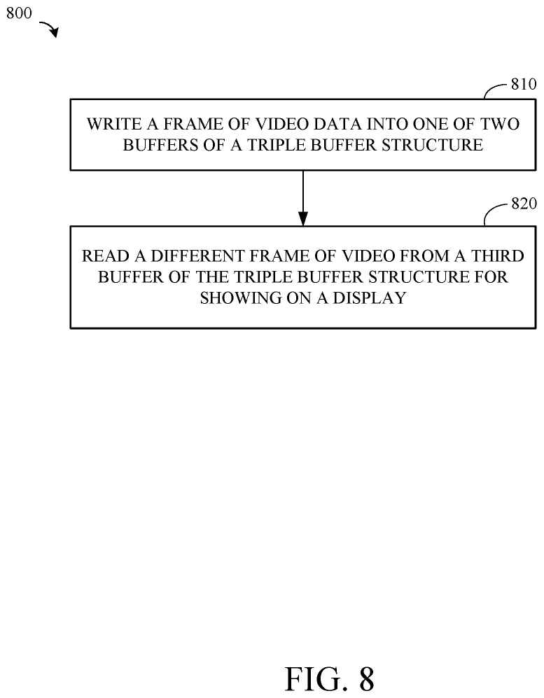

The image capture system 300 may be used to implement some or all of the techniques described in this disclosure, such as the technique 700 and the technique 800, respectively described with respect to FIGS. 7-8.

Referring next to FIG. 3B, another image capture system 330 is shown. The image capture system 330 includes an image capture device 340 and a personal computing device 360 that communicate via a communications link 350. The image capture device 340 may, for example, be the image capture device 100 shown in FIGS. 1A-D. The personal computing device 360 may, for example, be the user interface device described with respect to FIGS. 1A-D.

The image capture device 340 includes an image sensor 342 that is configured to capture images. The image capture device 340 includes a communications interface 344 configured to transfer images via the communication link 350 to the personal computing device 360.

The personal computing device 360 includes a processing apparatus 362 that is configured to receive, using a communications interface 366, images from the image sensor 342. The processing apparatus 362 may be configured to perform image signal processing (e.g., filtering, tone mapping, stitching, and/or encoding) to generate output images based on image data from the image sensor 342.

The image sensor 342 is configured to detect light of a certain spectrum (e.g., the visible spectrum or the infrared spectrum) and convey information constituting an image as electrical signals (e.g., analog or digital signals). For example, the image sensor 342 may include CCDs or active pixel sensors in a CMOS. The image sensor 342 may detect light incident through a respective lens (e.g., a fisheye lens). In some implementations, the image sensor 342 includes digital-to-analog converters. Image signals from the image sensor 342 may be passed to other components of the image capture device 340 via a bus 346.

The communications link 350 may be a wired communications link or a wireless communications link. The communications interface 344 and the communications interface 366 may enable communications over the communications link 350. For example, the communications interface 344 and the communications interface 366 may include an HDMI port or other interface, a USB port or other interface, a FireWire interface, a Bluetooth interface, a ZigBee interface, and/or a Wi-Fi interface. For example, the communications interface 344 and the communications interface 366 may be used to transfer image data from the image capture device 340 to the personal computing device 360 for image signal processing (e.g., filtering, tone mapping, stitching, and/or encoding) to generate output images based on image data from the image sensor 342.

The processing apparatus 362 may include one or more processors having single or multiple processing cores. The processing apparatus 362 may include memory, such as RAM, flash memory, or another suitable type of storage device such as a non-transitory computer-readable memory. The memory of the processing apparatus 362 may include executable instructions and data that can be accessed by one or more processors of the processing apparatus 362. For example, the processing apparatus 362 may include one or more DRAM modules, such as DDR SDRAM.

In some implementations, the processing apparatus 362 may include a DSP. In some implementations, the processing apparatus 362 may include an integrated circuit, for example, an ASIC. For example, the processing apparatus 362 may include a custom image signal processor. The processing apparatus 362 may exchange data (e.g., image data) with other components of the personal computing device 360 via a bus 368.

The personal computing device 360 may include a user interface 364. For example, the user interface 364 may include a touchscreen display for presenting images and/or messages to a user and receiving commands from a user. For example, the user interface 364 may include a button or switch enabling a person to manually turn the personal computing device 360 on and off In some implementations, commands (e.g., start recording video, stop recording video, or capture photo) received via the user interface 364 may be passed on to the image capture device 340 via the communications link 350.

The image capture system 330 may be used to implement some or all of the techniques described in this disclosure, such as the technique 700 and the technique 800, respectively described with respect to FIGS. 7-8.

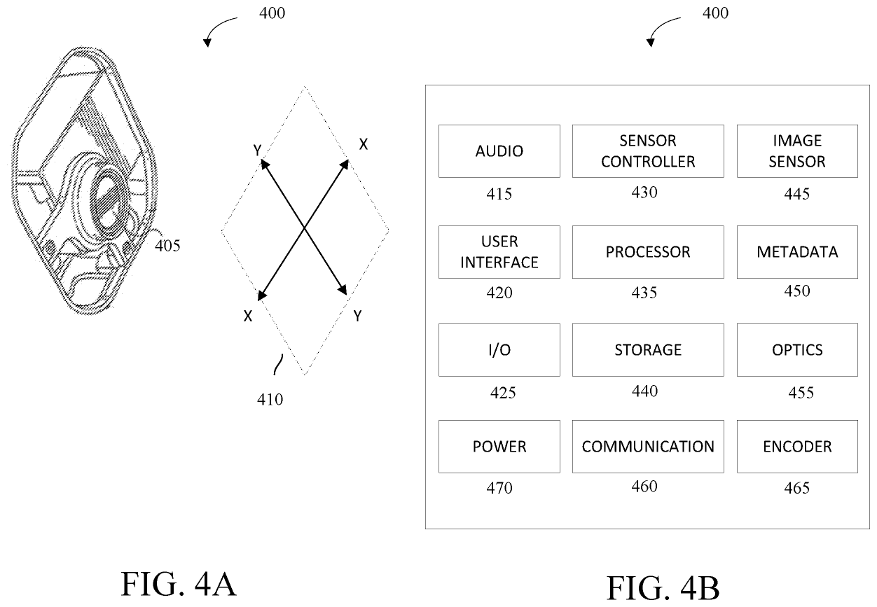

FIG. 4A is a perspective view of another example of an image capture device 400 together with an associated field-of-view and FIG. 4B is a schematic representation of the image capture device 400. The image capture device 400 includes one or more optical components or elements 405 with an associated field-of-view 410 that extends, for example, 90° in a lateral dimension X-X and 120° in a longitudinal dimension Y-Y. Dependent upon the capabilities of the particular optical component(s) 405, however, the extent of the field-of-view 410 may be varied (i.e., increased or decreased) in the lateral dimension or the longitudinal dimension. Suitable optical component(s) 405 may include one or more lenses, macro lenses, zoom lenses, special-purpose lenses, telephoto lenses, prime lenses, achromatic lenses, apochromatic lenses, process lenses, wide-angle lenses, ultra-wide-angle lenses, fisheye lenses, infrared lenses, ultraviolet lenses, spherical lenses, and perspective control lenses. In some image capture devices, multiple, overlapping fields of view are employed to increase the capability of the device, for example, by including two or more optical elements. For example, a first fisheye image may be a round or elliptical image, and may be transformed into a first rectangular image; a second fisheye image may be a round or elliptical image, and may be transformed into a second rectangular image; and the first and second rectangular images may be arranged side-by-side, which may include overlapping, and stitched together to form the equirectangular planar image.

As seen in FIG. 4A, in addition to the optical component(s) 405, the image capture device 400 may further include an audio component 415, a user interface (UI) unit 420, an input/output (I/O) unit 425, a sensor controller 430, a processor 435, an electronic storage unit 440, an image sensor 445, a metadata unit 450, an optics unit 455, a communication unit 460, an encoder 465, and power system 470. Suitable examples of the image sensor 445 may include a charge-coupled device (CCD) sensor, an active pixel sensor (APS), a complementary metal-oxide semiconductor (CMOS) sensor, an N-type metal-oxide-semiconductor (NMOS) sensor, and/or any other image sensor or combination of image sensors.

During the processing of images, it is envisioned that the processor 435 may process the video data for simultaneously driving dual displays with the same video data and different graphics. The processor 435 may implement some or all of the techniques described in this disclosure, such as the technique 700 and the technique 800, respectively described with respect to FIGS. 7-8.

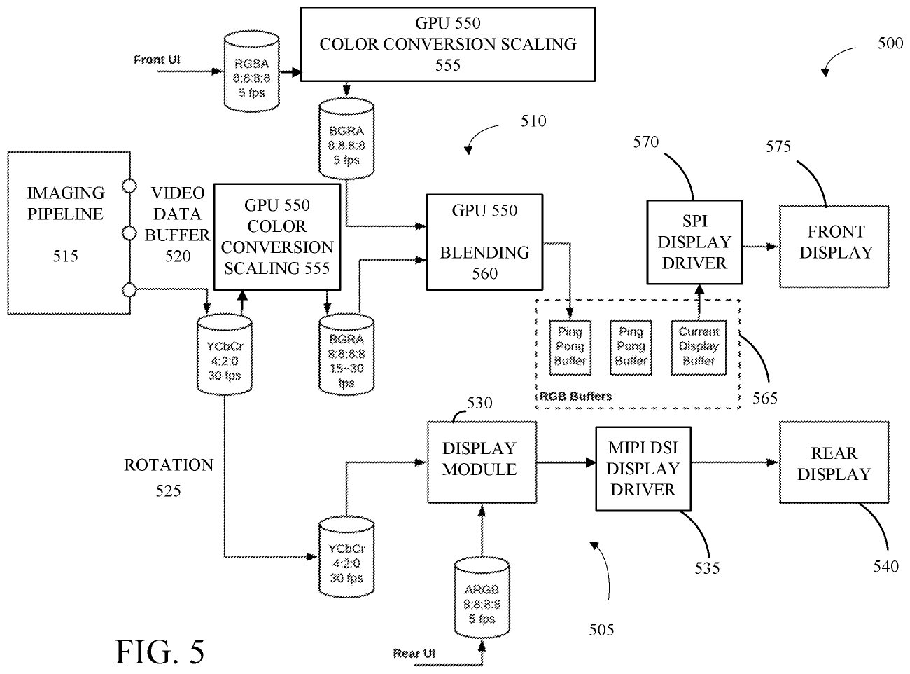

FIG. 5 is a block diagram of an example of an image capture and processing pipeline 500 for simultaneously driving dual displays with same camera video and different graphics. The image capture and processing pipeline 500 is implemented by an image capture device, which may, for example, be the image capture device 100 shown in FIGS. 1A-D, the image capture device 200 shown in FIGS. 2A-C, or another image capture device. In some implementations, some or all of the pipeline 500 may represent functionality of a DSP and/or an ASIC, for example, including an image capture unit, an image processing unit, a processor, or a combined image capture and processing unit.

The pipeline 500 includes a rear display processing pipeline 505 and a front display processing pipeline 510. The pipeline 500 includes an imaging pipeline 515, which processes video data captured by an image sensor, and outputs video data at a video data buffer 520. The video data may be in a defined color format. In some implementations, the video data is in a YCbCr color format.

The rear display processing pipeline 505 may include performing a rotation 525 on the YCbCr color formatted video data. The rear display processing pipeline 505 includes a display module 530 which processes and blends the YCbCr color formatted video data with rear display user interface graphics and text data. In some implementations, the display module 530 is a dedicated hardware circuit for processing video data. The blended video data is processed by a MIPI DSI display driver 535, which in turn generates signals based on the blended video data to drive a rear display 540. In some implementations, the rear display processing pipeline 505 processes the video data at a defined frames per second (fps) or frame rate. In some implementations, this frame rate is 30 fps. In some implementations, this frame rate is set by the frame rate of the incoming video data, which in FIG. 5 is shown as 30 fps.

The front display processing pipeline 510 includes a graphics processing unit (GPU) 550 which performs color conversion and scaling 555 on the YCbCr color formatted video data and outputs Red, Green, Blue, Alpha (RGBA) color formatted video data in a BGRA pixel order. The GPU 550 also performs color conversion and scaling 555 on the front display user interface graphics and text data and outputs BGRA color formatted front display user interface graphics and text data. The GPU 550 processes and blends 560 the BGRA color formatted video data with the BGRA color formatted front display user interface graphics and text data. The blended video data is stored in one buffer of a set of three buffers 565, while a second buffer stores a previous frame of video data and a third buffer is being read and processed by a serial peripheral interface (SPI) display driver 570 which generates signals based on the blended video data to drive a front display 575. In some implementations, the front display processing pipeline 510 processes the video data at a defined frames-per-second (fps) rate or frame rate. In some implementations, this frame rate is 30 fps. In some implementations, this frame rate is between 15-30 fps. In some implementations, this frame rate is set by the frame rate of the incoming video data, which in FIG. 5 is shown as 30 fps. In implementations, when the frame rate of the incoming video data is below 5 fps, the frame rate is set by the frame rate of the front display user interface graphics and text data, which in FIG. 5 is 5 fps. That is, the frame rate is set by the higher of the incoming video data or the front display user interface graphics and text data.

The set of three buffers 565 prevents stalling of the rear display processing pipeline 505 and maintains the frame rate at 30 fps. The video data is written to alternate buffers while the third buffer is displayed on the front display 575. The set of three buffers 565 are cycled on demand so as to not delay the frame rate and/or refresh rate of the front display 575 and/or the rear display 540.

In some implementations, the display module 530, the MIPI DSI display driver 535, the GPU 550, the buffers 565, and the SPI display driver 570 may be implemented as a system on chip (SoC). In an implementation, the pipeline processing may be configured such that the processing described for the rear display processing pipeline 505 is used for the front display and the processing described for the front display processing pipeline 510 is used for the rear display. In an implementation, the front display and the second display are liquid crystal displays.

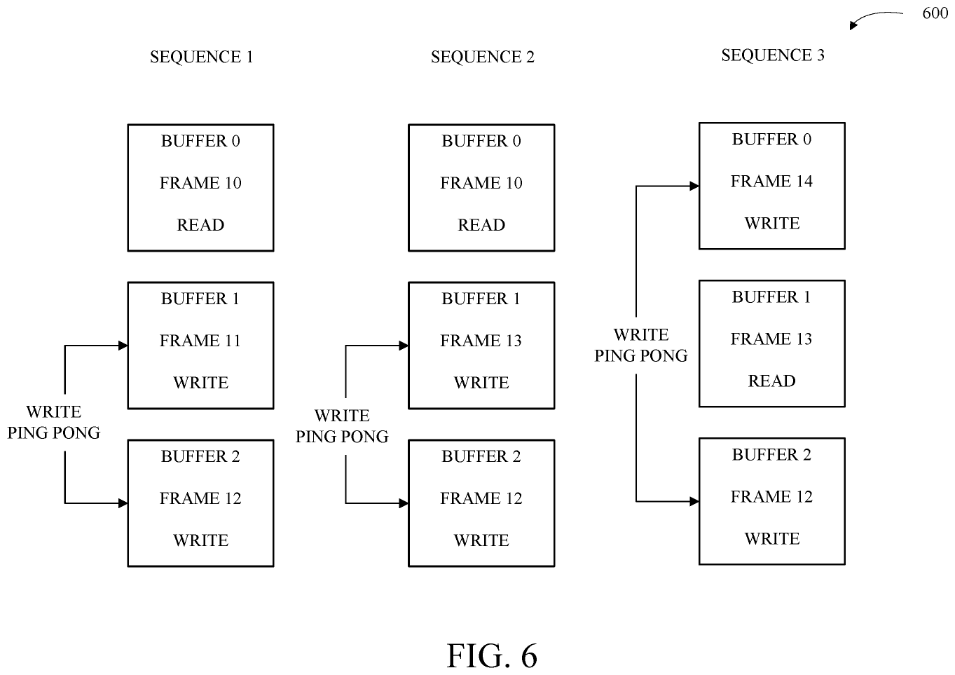

FIG. 6 is a flow diagram of an example of a triple buffering structure 600 for simultaneously driving dual displays with same camera video and different graphics. The triple buffering structure 600 includes a buffer 0, a buffer 1, and a buffer 2 for storing different frames of video data. In a sequence 1, the buffer 0 may include a frame 10, the buffer 1 may include a frame 11, and the buffer 2 may include a frame 12. In the sequence 1, the buffer 1 and the buffer 2 alternate for next incoming frame as the buffer 0 is being readout for display. That is, the buffer 1 and the buffer 2 are write ping pong buffers. In a sequence 2, as frame 10 is still being readout from the buffer 0, frame 13 is written into the buffer 1, and the buffer 2 still includes frame 12. In a sequence 3, frame 13 is now being readout of the buffer 1, frame 14 is now being written into the buffer 0, and the buffer 2 still includes frame 12. The buffer 0 and the buffer 2 now represent the write ping pong buffers. As stated, the triple buffering structure 600 permits maintenance of the desired frame rates.

FIG. 7 is a flowchart of an example technique 700 for simultaneously driving dual displays with same camera video data and different user interface graphics and text. The technique 700 includes: blending 705 a video data with a first user interface graphics and text to generate first video data for a first display; color converting 710 the video data for a second display; scaling 715 the color converted video data for the second display; blending 720 the scaled video data with a second user interface graphics and text to generate second video data for the second display; storing 725 the second video data in a buffer of a triple buffer structure; driving 730 the first video data to the first display using a first display driver; and driving 735 the second video data to the second display from another buffer in the triple buffer using a second display driver. For example, the technique 700 may be implemented by the image capture device 100 shown in FIGS. 1A-1D, the image capture device 200 shown in FIGS. 2A-2D, the image capture device 310 shown in FIGS. 3A-3B, or the image capture device 400 of FIGS. 4A-4B. The order is illustrative and may occur in other orders or in combined steps.

The technique 700 includes blending 705 a video data with a first user interface graphics and text to generate first video data for a first display. An image sensor in an image capture device captures video data. The video data is processed via an image processing pipeline. The processed video data is overlaid with first user interface graphics and text by a display module or dedicated display hardware associated with the first display.

The technique 700 includes color converting 710 the video data for a second display. A color format of the video data is converted from a first color format to a second color format. The color conversion is performed by a graphics processing unit.

The technique 700 includes scaling 715 the color converted video data for the second display. The video data is scaled by the GPU for use by the second display.

The technique 700 includes blending 720 the scaled video data with a second user interface graphics and text to generate second video data for the second display. The GPU overlays the color converted and scaled video data with the second user interface graphics and text.

The technique 700 includes storing 725 the second video data in a buffer of a triple buffer structure. The second video data is stored in one buffer of a triple buffer structure.

The technique 700 includes driving 730 the first video data to the first display using a first display driver. The first display driver generates signals from the first video data to drive the first display. In an implementation, the first display is a rear display and the first display driver is a DSI compatible driver.

The technique 700 includes driving 735 the second video data to the second display from another buffer in the triple buffer using a second display driver. The second display driver reads the second video data from another buffer of the triple buffer structure and generates signals from the second video data to drive the second display. In an implementation, the second display is a front display and the second display driver is a SPI compatible driver.

FIG. 8 is a flowchart of an example technique 800 for triple buffering for simultaneously driving dual displays with same camera video data and different user interface graphics and text. The technique 800 includes: writing 810 a frame of video data into one of two buffers of a triple buffer structure; and reading 820 a different frame of video from a third buffer of the triple buffer structure for showing on a display. For example, the technique 800 may be implemented by the image capture device 100 shown in FIGS. 1A-1D, the image capture device 200 shown in FIGS. 2A-2D, the image capture device 310 shown in FIGS. 3A-3B, or the image capture device 400 of FIGS. 4A-4B. For example, the technique 800 may be implemented in the technique 700 of FIG. 7. The order is illustrative and may occur in other orders or in combined steps.

The technique 800 includes writing 810 a frame of video data into one of two buffers of a triple buffer structure. An image sensor in an image capture device captures video data. The video data is processed via an image processing pipeline. For one of the dual displays, the image processing pipeline and system includes a triple buffer structure. A frame of the processed video data is written into in one of two buffers.

The technique 800 includes reading 820 a different frame of video from a third buffer of the triple buffer structure for showing on a display. A display driver reads a different frame of the video data from a third buffer in the triple buffer structure.

Where certain elements of these implementations may be partially or fully implemented using known components, those portions of such known components that are necessary for an understanding of the present disclosure have been described, and detailed descriptions of other portions of such known components have been omitted so as not to obscure the disclosure.

In the present specification, an implementation showing a singular component should not be considered limiting; rather, the disclosure is intended to encompass other implementations including a plurality of the same component, and vice-versa, unless explicitly stated otherwise herein. Further, the present disclosure encompasses present and future known equivalents to the components referred to herein by way of illustration.

As used herein, the term “bus” is meant generally to denote any type of interconnection or communication architecture that may be used to communicate data between two or more entities. The “bus” could be optical, wireless, infrared, or another type of communication medium. The exact topology of the bus could be, for example, standard “bus,” hierarchical bus, network-on-chip, address-event-representation (AER) connection, or other type of communication topology used for accessing, for example, different memories in a system.

As used herein, the terms “computer,” “computing device,” and “computerized device” include, but are not limited to, personal computers (PCs) and minicomputers (whether desktop, laptop, or otherwise), mainframe computers, workstations, servers, personal digital assistants (PDAs), handheld computers, embedded computers, programmable logic devices, personal communicators, tablet computers, portable navigation aids, Java 2 Platform, Micro Edition (J2ME) equipped devices, cellular telephones, smartphones, personal integrated communication or entertainment devices, or another device capable of executing a set of instructions.

As used herein, the term “computer program” or “software” is meant to include any sequence of machine-cognizable steps which perform a function. Such program may be rendered in any programming language or environment including, for example, C/C++, C#, Fortran, COBOL, MATLAB™, PASCAL, Python, assembly language, markup languages (e.g., HTML, Standard Generalized Markup Language (SGML), XML, Voice Markup Language (VoxML)), as well as object-oriented environments such as the Common Object Request Broker Architecture (CORBA), Java™ (including J2ME, Java Beans), and/or Binary Runtime Environment (e.g., Binary Runtime Environment for Wireless (BREW)).

As used herein, the terms “connection,” “link,” “transmission channel,” “delay line,” and “wireless” mean a causal link between two or more entities (whether physical or logical/virtual) which enables information exchange between the entities.

As used herein, the terms “integrated circuit,” “chip,” and “IC” are meant to refer to an electronic circuit manufactured by the patterned diffusion of trace elements into the surface of a thin substrate of semiconductor material. By way of non-limiting example, integrated circuits may include FPGAs, PLDs, RCFs, SoCs, ASICs, and/or other types of integrated circuits.

As used herein, the term “memory” includes any type of integrated circuit or other storage device adapted for storing digital data, including, without limitation, read-only memory (ROM), programmable ROM (PROM), electrically erasable PROM (EEPROM), DRAM, Mobile DRAM, synchronous DRAM (SDRAM), Double Data Rate 2 (DDR/2) SDRAM, extended data out (EDO)/fast page mode (FPM), reduced latency DRAM (RLDRAM), static RAM (SRAM), “flash” memory (e.g., NAND/NOR), memristor memory, and pseudo SRAM (PSRAM).

As used herein, the term “Wi-Fi” includes one or more of IEEE-Std. 802.11, variants of IEEE-Std. 802.11, standards related to IEEE-Std. 802.11 (e.g., 802.11 a/b/g/n/s/v), and/or other wireless standards.

As used herein, the term “wireless” means any wireless signal, data, communication, and/or other wireless interface. By way of non-limiting example, a wireless interface may include one or more of Wi-Fi, Bluetooth, 3G (3GPP/3GPP2), High Speed Downlink Packet Access/High Speed Uplink Packet Access (HSDPA/HSUPA), Time Division Multiple Access (TDMA), Code Division Multiple Access (CDMA) (e.g., IS-95A, Wideband CDMA (WCDMA), and/or other wireless technology), Frequency Hopping Spread Spectrum (FHSS), Direct Sequence Spread Spectrum (DSSS), Global System for Mobile communications (GSM), PAN/802.15, WiMAX (802.16), 802.20, narrowband/Frequency Division Multiple Access (FDMA), Orthogonal Frequency Division Multiplex (OFDM), Personal Communication Service (PCS)/Digital Cellular System (DCS), LTE/LTE-Advanced (LTE-A)/Time Division LTE (TD-LTE), analog cellular, Cellular Digital Packet Data (CDPD), satellite systems, millimeter wave or microwave systems, acoustic, infrared (i.e., IrDA), and/or other wireless interfaces.

As used herein, the terms “camera,” or variations thereof, and “image capture device,” or variations thereof, may be used to refer to any imaging device or sensor configured to capture, record, and/or convey still and/or video imagery which may be sensitive to visible parts of the electromagnetic spectrum, invisible parts of the electromagnetic spectrum (e.g., infrared, ultraviolet), and/or other energy (e.g., pressure waves).

While certain aspects of the technology are described in terms of a specific sequence of steps of a method, these descriptions are illustrative of the broader methods of the disclosure and may be modified by the particular application. Certain steps may be rendered unnecessary or optional under certain circumstances. Additionally, certain steps or functionality may be added to the disclosed implementations, or the order of performance of two or more steps may be permuted. All such variations are considered to be encompassed within the disclosure.

While the above-detailed description has shown, described, and pointed out novel features of the disclosure as applied to various implementations, it will be understood that various omissions, substitutions, and changes in the form and details of the devices or processes illustrated may be made by those skilled in the art without departing from the disclosure. The foregoing description is in no way meant to be limiting, but rather should be taken as illustrative of the general principles of the technology.

What is claimed is:

1. An image capture device comprising:
an image sensor configured to capture image information;
a display module configured to blend the image information with first user interface graphics and text to generate first image information for a first display;
a processor configured to:
process the image information for use for a second display;
blend the processed image information with second user interface graphics and text to generate second image information for a second display; and
store the second image information in a buffer of a triple buffer structure;
a first display driver for generating signals from the first image information to drive the first display; and
a second display driver for generating signals from the second image information to drive the second display,
wherein the first display driver and the second display driver are different display driver types.

2. The image capture device of claim 1, wherein the first display is a rear display and the second display is a front display.

3. The image capture device of claim 1, the storing comprising:
storing a frame of the second image information in one of a pair of buffers of the triple buffer structure.

4. The image capture device of claim 3, the storing comprising:
reading a different frame of the second image information from another buffer of the triple buffer structure.

5. The image capture device of claim 1, the processing comprising:
color converting the image information for use for the second display.

6. The image capture device of claim 5, the processing comprising:
scaling the color converted image information for use for the second display.

7. The image capture device of claim 6, the processing comprising:
color converting the second user interface graphics and text for use for the second display.

8. The image capture device of claim 7, the processing comprising:
scaling the color converted second user interface graphics and text for user for the second display.

9. A method for simultaneously driving dual displays with video data, the method comprising:
overlaying, by a display module, the video data with rear user interface graphics and text to generate rear video data for a rear display;
processing, by a processor, the video data for a front display;
overlaying the processed video data with front user interface graphics and text to generate front video data for the front display;
storing the front video data in a buffer of a triple buffer structure;
generating a first type of driving signals from the rear video data to drive the rear display; and
generating a second type of driving signals from the front video data to drive the front display,
wherein the first type of driving signals and the second type of driving signals are different driving signals.

10. The method of claim 9, further comprising:
storing a frame of the front video data in one of a pair of buffers of the triple buffer structure.

11. The method of claim 10, further comprising:
reading a different frame of the front video data from another buffer of the triple buffer structure.

12. The method of claim 9, the processing comprising:
color converting the video data for use for the front display.

13. The method of claim 12, the processing comprising:
scaling the color converted video data for use for the front display.

14. The method of claim 13, the processing comprising:
color converting the front user interface graphics and text for use for the front display.

15. The method of claim 14, the processing comprising:
scaling the color converted front user interface graphics and text for use for the front display.

16. A system for simultaneously driving dual displays with video data comprising:
an image sensor configured to capture the video data;
a display module configured to overlay the video data with rear user interface graphics and text to generate rear video data for a rear display;
a processor, in cooperation the display module, configured to
process the video data for a front display;
overlay the processed video data with front user interface graphics and text to generate front video data for the front display;
store the front video data in a buffer of a triple buffer structure;
generate a first type of driving signals from the rear video data to drive the rear display; and
generate a second type of driving signals from the front video data to drive the front display,
wherein the first type of driving signals and the second type of driving signals are different driving signals.

17. The system of claim 16, further comprising:
the processor configured to store a frame of the front video data in one of a pair of buffers of the triple buffer structure.

18. The system of claim 16, further comprising:
the processor configured to read a different frame of the front video data from another buffer of the triple buffer structure.

19. The system of claim 16, further comprising:
the processor configured to:
color convert the video data for use for the front display; and
scale the color converted video data for use for the front display.

20. The system of claim 19, further comprising:
the processor configured to:
color convert the front user interface graphics and text for use for the front display; and
scale the color converted front user interface graphics and text for use for the front display.
